(19) United States
(12) Patent Application Publication
(10) Pub. No.: US 2011/0137917 A1
(43) Pub. Date: Jun. 9, 2011

(54) RETRIEVING A DATA ITEM ANNOTATION IN A VIEW

(75) Inventors: James P. Boland, Kanata (CA); Christopher C. Massey, Four Marks (GB); Michael D. Vallender, Walton-on-Thames (GB)

(73) Assignee: INTERNATIONAL BUSINESS MACHINES CORPORATION, Armonk, NY (US)

(21) Appl. No.: 12/894,392

(22) Filed: Sep. 30, 2010

(30) Foreign Application Priority Data
Dec. 3, 2009 (EP) 09177866.2

(51) Int. Cl. G06F 17/30; G06F 17/00

(52) U.S. Cl. 707/747; 707/758; 715/230; 707/E17.002; 707/E17.014

(57) ABSTRACT

A method of retrieving an annotation associated with a data item in a view generated by an information management system querying a data source, includes receiving an output of a query; analyzing the output of the query to identify one or more data items having a data value and an attribute associated therewith; for each identified data value and attribute, identifying a unique value associated with the data value and the attribute, wherein an identified unique value associated with the data value and an identified unique value associated with the attribute forms a unique set of values; identifying from a data store a previously logged set of unique values corresponding to the set of unique values; in response to a positive determination, determining whether the previously logged unique set of values are an associated annotation; and in response to a positive second determination retrieving the annotation from the data store.

### CROSS-REFERENCE TO RELATED APPLICATIONS

This application claims priority to European Patent Application No. 09177866.2, filed Dec. 3, 2009, and all the benefits accruing therefrom under 35 U.S.C. §119, the contents of which in its entirety are herein incorporated by reference.

### BACKGROUND

The invention relates to the field of information management. In particular, the invention relates to an improved method for associating annotations with data items in a view.

Information management systems comprise tools and applications that store, analyze and perform some form of computation on the data to provide some meaningful understanding of the data to a user.

An information management system may comprise any number of applications that collect, analyze and report information such as database applications and spreadsheet applications. Using an example of a relational database application—a relationship model is used to define the relationship between data elements having attributes in common with other data elements. For example, a customer may have a ‘one to many’ relationship with an invoice, meaning that a customer may have ‘many’ invoices, but an invoice does not have ‘many’ customers because an invoice tends to be unique to a specific customer. Once the relationships have been defined, it is then possible to create queries that exploit the pre-defined relationships to provide meaningful reports. For example, a query may be defined to query a data source to find out how many outstanding invoices a particular customer has.

In an online analytical processing system the underlying data structure is modelled on, typically, a star or snowflake schema. The system comprises numeric facts that are known as measures and that are categorized by what is known as dimensions. Measures are derived from records in a fact table and dimensions are derived from a dimension table. In a data warehouse, a dimension is a data element that categorizes each item in a data set into non-overlapping regions. A view is generated that displays measures and facts associated with the measure i.e., data and descriptors that describe a property of the data. For example, data could take the form of a ‘plasma screen TV’ and a dimension of ‘plasma screen TV’ is ‘product’.

Another example can be found in a spreadsheet wherein data is populated in cells that ‘make up’ columns and rows. Often, some computational analysis takes place using the data and the results are displayed, for example, in a tabular form, etc.

However, what all of the above types of applications have in common is that data is analyzed and results are displayed to a user for review and/or further analysis.

Often, when a report or view is generated, a viewer of the report may wish to annotate one or more items in the report/view. Although this is possible by adding a comment to a cell in which the data is located, a problem occurs when a query is re-run and the report data is then subsequently refreshed. This is because the comment does not follow the data that was displayed at a first location in the report, and on refreshing the report the data is now displayed at a second location in the report. The problem is that the comment is still being displayed at the first location but the data has moved to a different location and thus the comment now refers to the incorrect data.

One prior art solution for solving this problem can be found in U.S. patent application 2006/0212469 that describes a method for associating item metadata with an item in a spreadsheet, such that when the item moves to a different cell in the spreadsheet the comments move with the item too. This is achieved by creating an index in the spreadsheet itself that creates an index to a metadata table. However, a problem with this solution is that although the item metadata will move with the item in the table to a new cell, this solution only works if the data is contained within the spreadsheet itself. Thus, the prior art still relies on the cell location of the data to determine the location to move the comment. This solution does not work in situations where the data is provided by external data sources and/or a query that generated the report is re-run. Further, the prior art solution requires the metadata index to be ‘inserted’ into the item's cell, thus requiring the underlying spreadsheet's structure to be modified with an ID field.

### SUMMARY OF THE INVENTION

In one aspect, the present invention provide a method of retrieving an annotation associated with a data item in a view, wherein the view is generated by an information management system querying a data source, the method including: receiving an output of a query; analyzing the output of the query to identify one or more data items, wherein a data item comprises a data value and an attribute associated with the data value; generating an index using at least some of the identified attributes and data values; using the index to determine if the output of the query is associated with an annotation and if the output of the query is associated with an annotation, retrieving the annotation from the data store.

Other embodiments include apparatus and a program-readable storage medium containing program code for accomplishing the above method.

In another aspect, the invention provides a method of retrieving an annotation associated with a data item in a view, wherein the view is generated by an information management system querying a data source, the method including: receiving an output of a query; analyzing the output of the query to identify one or more data items, wherein a data item comprises a data value and an attribute associated with the data value; for each identified data value and attribute, identifying a unique value associated with each of the identified data values and attributes; identifying from a data store if a data entry that corresponds to the identified unique value; in response to a positive determination, determining whether the identified unique value is associated with an annotation; and in response to a positive second determination retrieving the annotation from the data store.

Additional embodiments include apparatus and a program-readable storage medium containing program code for accomplishing the immediately above method.

### BRIEF DESCRIPTION OF THE SEVERAL VIEWS OF THE DRAWINGS

Embodiments of the invention will now be described, by means of example only, with reference to the accompanying drawings in which:

FIGS. 1a and 1b are schematic representations of a conventional data processing system in which an exemplary embodiment of the presentation invention might operate;

FIG. 2 is a schematic diagram detailing an information management system as known in the art;

FIG. 3 is a schematic diagram detailing the components of the information management system in accordance with an exemplary embodiment of the present invention;

FIG. 4 is a schematic diagram showing an example of an information management system generated report with associated annotations in accordance with an exemplary embodiment of the present invention;

FIG. 5 is a schematic diagram showing the components of an index creator component, in accordance with an exemplary embodiment of the present invention;

FIGS. 6a and 6b are schematic diagrams showing an example view and the tuples that represent dimensions in the view, in accordance with an exemplary embodiment of the present invention; and

FIG. 7 is a flow chart detailing the process steps of the database application in accordance with an exemplary embodiment of the present invention.

### DETAILED DESCRIPTION

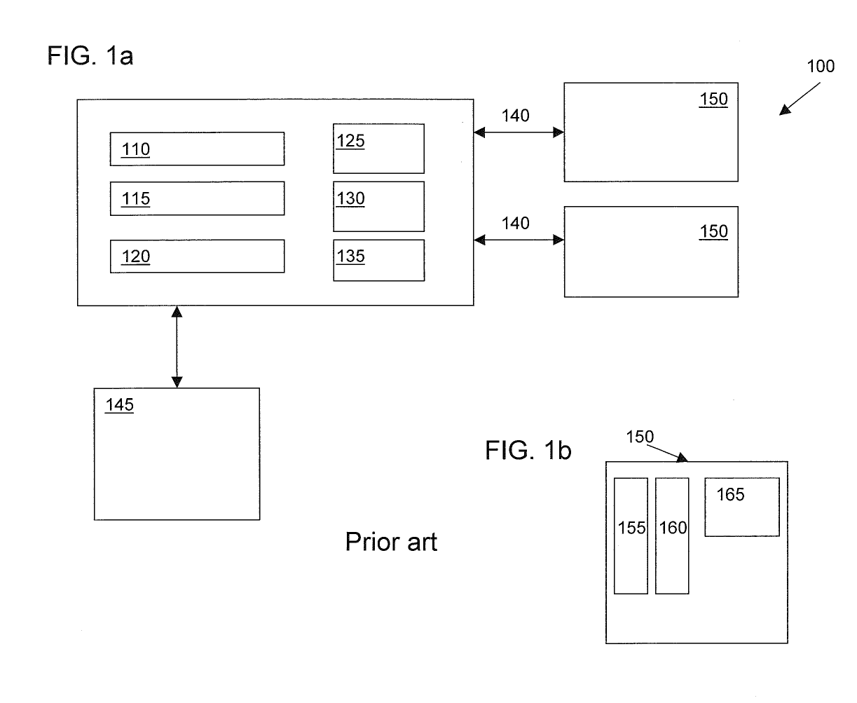

FIGS. 1a and 1b detail a data processing system 100 suitable for use with an exemplary embodiment of the present invention. The data processing system 100 comprises hardware 115 and software 120 for cooperating with each other to provide benefits of the present invention embodiments. Typically, the data processing system 100 comprises some form of storage means 120 in which to store data either locally on the data processing system or via storage means 145 that is external to the data processing system 100; storage and memory means 115 for storing and running an information management application operable for use on said data processing system; input means 125 for inputting instructions and data associated with the operation of the information management application and a display means 130 for viewing an output of the database application.

The information management application may either operate in a server mode 135 or client mode 150. When operating in a server mode 135 client devices 150 are operable for connecting to the server via a network 140. A client device 150 can connect to the server 135 via any form of wired 140 or wireless network means 140.

The client device 150 comprises input 155 as shown in FIG. 1b and output means 160, and memory and storage means 165 for interacting with the data processing system 100. A client device 150 is any device that comprises input/output processing means, such as a laptop computer, desktop computer, notebook computer, mobile phone or other multifunctional hand-held mobile computing device. The data processing system 100 operating in server mode 135 is operable for communicating with and receiving instructions from multiple client devices 150.

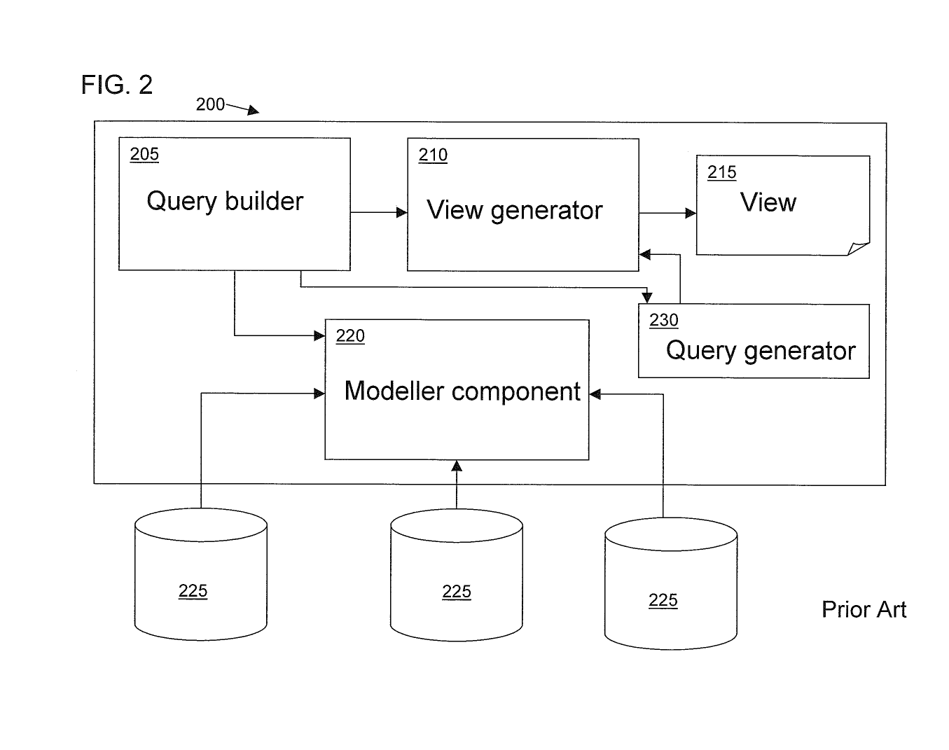

FIG. 2 details an information management system 200 as known in the art. However, a person skilled in the art will appreciate that the invention is applicable to any active database application or spreadsheet application whereby data is analyzed and reported. This definition is deemed to cover online transaction processing applications, as well as data mining applications, relational database applications, multi-dimensional databases and also spreadsheet applications, etc., which share many characteristics associated with database applications, etc. The present invention embodiments are intended to be applicable to any application that displays results from generated queries in a formatted manner and wherein annotations associated with displayed data need to be continually associated with the displayed data when the displayed data moves to another location in the formatted display.

A data store 225 stores data relating to an activity or to an entity to provide historical, current and predictive analysis and views of business operations when analyzed by an information management system 200. The data store 225 can take the form of a data warehouse or a data mart as is well known in the art.

The data store 225 can be located separately from the information management application 200 i.e., on a different server but within the same server rack or at a different geographical location to the information management system 200. Alternatively, the data store 225 may be located on the same server as the information management system 200. The data make take the form of structured data; typically, structured data is data that is modelled by a data model. Alternatively, the data may be unstructured data, i.e., data found in emails, SMS, instant messaging that require semantic analysis to analyze and report the meaning of the data.

In an exemplary embodiment, a modeller component 220 provides a means in which to model the underlying data to describe how data is represented and accessed. Data models, typically, define data elements and relationships between the defined data elements. A data model may be a relationship entity model or a star or snowflake schema, etc.

A query builder 205 enables a user to build queries for execution by a query generator component 230. The query generator component 230 analyzes the data located in the relevant data store 225 and returns the relevant data in the form of a view or a report 215. A query may take the form of ‘how many television sets were sold in a number of geographies in 1998?’ A view generator 210 receives the generated query from the query generator component 230 and generates a view 215 for displaying the results of the query.

A view 215 or report 215 can be in the form or any format as defined by a user. A view 215 can also be described as a view 215 of an aspect of a raw data set that has been queried based on a user defined criterion. The term view 215 is used to describe any form of output display whereby results of a query are displayed to a user. A view 215 or a report 215 is typically generated after a query has been performed on a data source. The view 215 or report 215 displays the results of the query. The term ‘view’ will be used throughout the rest of this specification and is understood to cover all display outputs of a query.

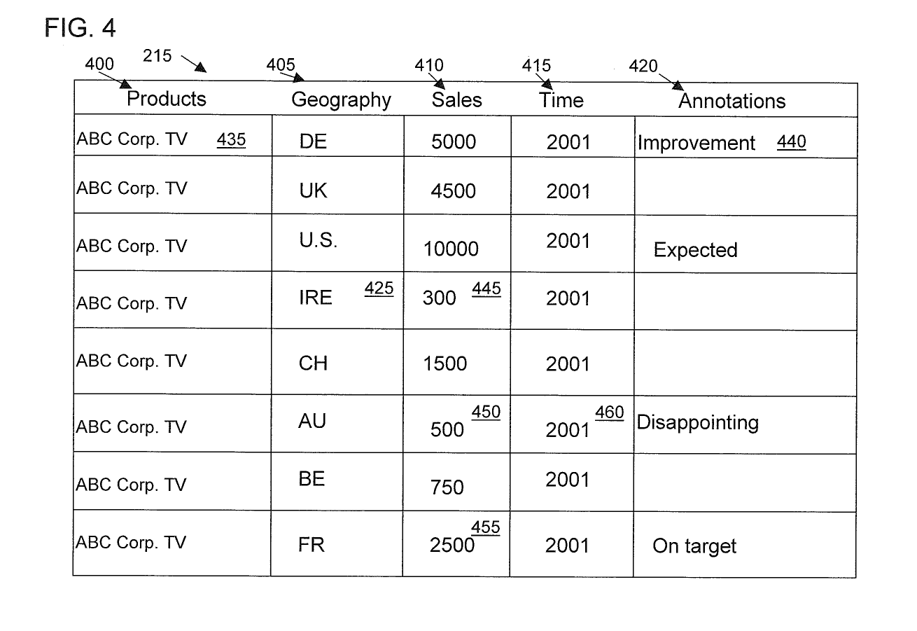

A simplified output of a query is shown in FIG. 4. The view 215 is the output of a query of ‘how many of ABC Corp's televisions where sold worldwide in 2001’. Whereby, a first column 400 lists the relevant product, i.e., television sets, a second column 405 lists geography, a third column 410 lists the number of sales or the measure and a third column 415 lists the timescale, i.e., the time period queried. Each row 435 displays the result of the query as categorised by the column headings. The intersection between a column 400 and a row 435 is a cell 440 or also known as a dimension 425 and a dimension comprises a data value 445. A data value can be regarded as data that may be generated from a query.

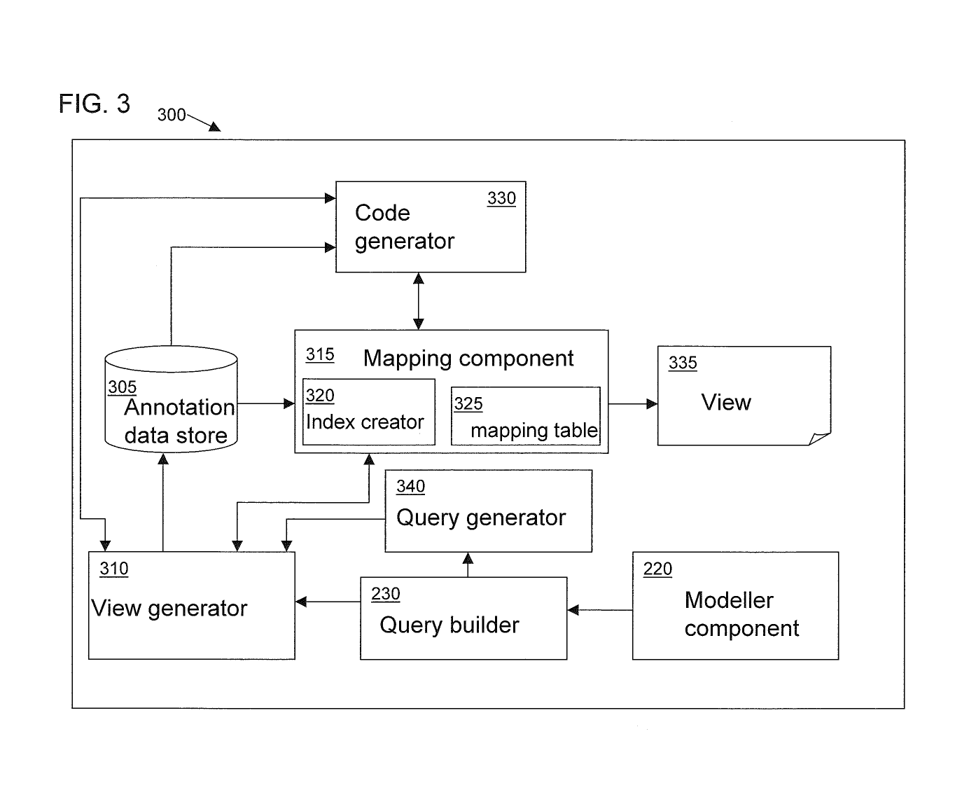

FIG. 3 details an exemplary embodiment of the present invention. There are a number of core components that are shared with the prior art information management application, namely a data store 225 (shown in FIG. 2), a modeller component 220 and a query builder 205; thus these components will not be explained in any further detail.

In accordance with an exemplary embodiment of the present invention, a modified information management system 300 comprises an annotation data store 305, a modified query generator component 340, a modified view generator component 310 for generating a view 335, a mapping component 315, a mapping table 325, an index creator component 320 for creating an index tuple table, and a code generator component 330.

When a query is submitted by a user, the query builder component 205 formats the query into a query language and the query generator component 340 queries a data store 225 for the required information. In an exemplary embodiment of the invention, the query generator component 340 returns the query to the view generator component 310 as a set of tuples. A tuple comprises a set of values wherein each of the values in the tuple represents a dimension in the database table. For example, if a query is generated that asks ‘how many television sets were sold in Germany in 2001’—the query may return the following data:
“500 television sets were sold in Germany in 2001”

A person skilled in the art would realize that this example is for illustration purposes only and that typically, the result may be returned in a structured tabular format as is shown in FIG. 4.

However, for efficient storage and retrieval purposes the result may be stored as a tuple in a data store 305 as follows:
<product=television sets, country=Germany, time=2001, measure=500>

A person skilled in the art will realize that the above tuple is for illustration purposes only and that in practice the tuple will be of a more complex data structure.

It is important to note that the tuple not only stores the result of a query (the data values) but also row, column heading and sub-headings that relate to the results of the query. Thus the tuple stores data values and the data values' attributes. The term data item will be used through out the description to describe a data value and its associated dimension or attribute.

FIG. 4 further illustrates a simplified view of the results of a query for the sales of ABC Corp's Plasma television sets. For illustration purposes only, a sixth column is shown wherein a user can add comments/annotations 440 to a row in the report. In this example, the annotation that a user has added for the number of TV sets sold in Germany in 2001 is of ‘improvement’ 440. This annotation 440 is associated with the entire row 435 but could also be associated with one of the data items 425, 445, 450 rather than the totality of the data items making up the row. Thus for this example, the tuple may be as follows:

<product = television sets, country = Germany, time = 2001,
measure = 500, annotation = improvement>

Annotations 440 may take the form of a character string, integer value or a link or a pointer to an external data source. The external data source 225 may be a web page, a document or any other form for conveying information.

Annotations 440 may be associated with any number of data items that are displayed in cells, columns and rows making up the entirety of the report, or an annotation may be associated with a single data item associated with a particular cell location.

An annotation 440 may be associated with a data item while the user is viewing a report or the annotation may be displayed when a query is refreshed and the dimensions are updated and displayed in a different view.

An annotation 440 may be displayed at a cell location 425, 450, 455 in which one or more associated data item(s) are being displayed or in an additional column as illustrated in FIG. 4. Or, alternatively, the annotation 440 could be displayed by ‘hovering’ the mouse over a row that comprises the data item(s) with which the annotation is associated. The annotation 440 may be displayed in a dialogue box via other display means that is triggered via a mouse or menu function operation. A person skilled in the art will realize that there are a number of ways in which to display an annotation 440 associated with a data item without departing from the scope of the invention.

Annotations 440 are stored in an annotation table in an annotation data store 305. Annotations 440 can be amended or deleted (or further annotations associated with a data item) and all changes are updated and reflected in the annotation table in the annotation data store 305.

Thus, an annotation 440 can also be associated with the aggregated total displayed in a column rather than a row because an annotation 440 can be associated with any data value 440 or a data value's attributes 400, 405, 410, 415, 420 in any cell location in a view or a report.

In order to associate the annotation with one or more data items displayed in a view 330, the annotation is linked to the tuple generated as part of a result of a query.

For example, using the view shown in FIG. 4, a tuple comprising the annotation of ‘improvement’ might be as follows:

<product = ABC Corp's plasma TV, geography= DE, time= 2001,
value = 5000, annotation = improvement>

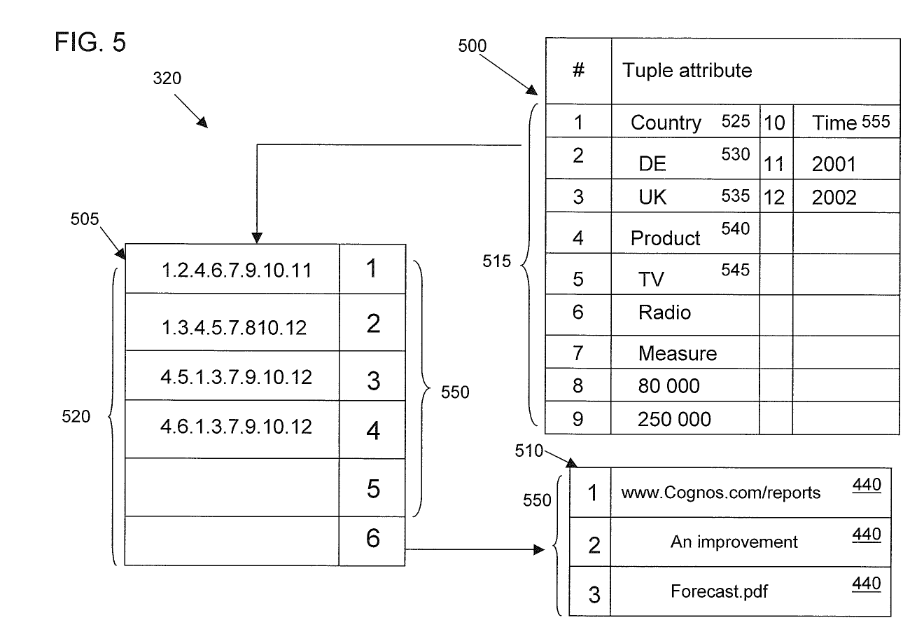

With reference to FIG. 5, the data items contained in the above tuple are stored in a tuple index table 505 in the annotation store 305 and the annotation 440 is stored in an annotation table 510 in the annotation store 305. A tuple stored in the tuple index table 505 is linked via a uniquely generated key 550 to its associated annotation 440 in the annotation table 510. However, a person skilled in the art would realize that there are other storage configurations possible without departing from the scope of the invention. In the above example, the character string ‘Improvement’ 440 will also be stored in the annotation table 510 in the annotation data store 305. However, if the annotation 440 is referring to a web page then a URL reference to the web page will be stored in the annotation table 510 in the annotation data store 305.

In order to retrieve the annotation associated with a tuple, an index creator component 320 creates an index 520 of stored tuples.

In this example, an index creator table 500 comprises a number of rows 525-545, each row 525-545 representing a uniquely identified data item in a tuple or the underlying data schema. For example, if the underlying data schema is a star schema comprising a facts table having dimensions of geography, comprising, country, address and postcode, products comprising televisions, radio, audio systems, toasters, year comprising 2001, 2002, 2003, 2004 and 2005, then these data items may also be listed in the index creator table 500. Thus, the number of rows within the table increases linearly with the number of dimensions associated with the star schema. Alternatively, a row 525-545 in the index creator table 500 may be created on the first commit storage operation of a data item in the tuple, i.e., on detection of a save operation of the annotation and the annotation's associated tuple.

Firstly, the index creator component 320 analyzes the tuple to be committed to storage, detects the first data item in the tuple, performs a lookup in the index creator table 500 and detects if the first data item identified in the tuple is located in a row 525-545 of the table.

If the determination is negative, i.e., the first data item is not present, then the first data item is placed into a row 525-545 of the table 500 and given a unique generated identifier 515. The generated identifier 515 is stored in the index creator table 325. This process is continued for each data item in the tuple until all data items in the tuple have been analyzed. There may be many tuples having many data items for each commit operation.

For example, taking the following: tuple

<Country = Germany, product = television sets, time = 2001,
measure = 5000, annotation = improvement>

The index creator component 320 begins by looking at the first data item located in the tuple, i.e., ‘country’ and identifies that there is no entry in the index creation table 500 for ‘country’ and places the data item ‘country’ into an available row 525 in the table 325 and assigns ‘country’ with a unique identifier 515 of, for example, the value 1 (a unique value is generated for each unique entry in the table 500). The index creator component 320 locates the next item in the tuple, i.e., ‘Germany’—determines that there is no entry in the index creator table for ‘Germany’ and adds the data item ‘Germany’ (country code ‘DE’) to the next available row 530 in the index creator table 500 and assigns the value ‘2’ to the data item ‘Germany’. Next, the index creator component 320 locates the next item in the tuple, i.e., ‘Product’—determines that there is no entry in the index creator table 500 for ‘Product’ and adds the data item ‘Product’ to the next available row 540 in the index creator table 500 and assigns the value ‘4’ to the data item ‘Product’. Next, the index creator component 320 locates the next item in the tuple i.e. ‘TV’—determines that there is no entry in the index creator table for ‘TV’ and adds the data item ‘TV’ to the next available row 545 in the index creator table 500 and assigns the value ‘5’ to the data item TV. Next, the index creator component 320 locates the next item in the tuple i.e. ‘Time’ and determines that there is no entry in the index creator table 500 for ‘Time’ and adds the data item ‘Time’ to the next available row 555 in the index creator table 500 and assigns the value ‘10’ to the data item ‘Time’. This process is continued for each data item identified in the tuple—such that each data item has been logged in the index creation table 500 and a unique value generated and associated with the each of the data items.

If the index creator component 320 identifies an annotation attribute in the tuple, the index creator component 320 writes the annotation value, i.e., the character string, integer value, pointer or link to further information to an annotation table 510 in the data store 305 and creates a unique key 550 and associates the unique key 550 with the annotation 440. There may be many annotations for any given tuple. The unique key 550 is also associated with the corresponding set of data values 520 in the tuple index table 505. Other information may be stored with the annotation such as, who created the annotation, and at what date and time was the annotation created.

The above described process is performed for each tuple and associated annotation that is committed to storage. This can take place when a user is adding an annotation while viewing the view or each time a report is refreshed and all existing annotations are ‘pulled’ into the report.

On subsequent detection of commit operations to the annotation data store 305, the index creator component 320 will again analyze each data item of the tuple. When the index creator component 320 performs a lookup in the index creation table 500 and detects that the data item of the tuple is already logged in the index creation table 500 then the index creator component 320 moves to the next item in the tuple and detects if the next data item is logged in the index creation table 500. If the data item is logged then, once again the index creator component 320 moves to the next data item in the tuple until all data items have been analyzed and checked against the entries logged in the index creation table 500. It is only when the index creator component 320 determines that a data item of a tuple is not logged in the index creation table 500 that the index creator component 320 logs the data item in the index creation table 500 and generates a unique identifier 515 to associate with the item logged in the index creation table 500. A data item also comprises an annotation associated with data items in a view.

If the index creator component 320 detects that the data item is already logged in the index creation table 500, then the index creator component 320 identifies the unique identifier 515 associated with data item and writes the unique identifier 515 to a tuple index table 505.

Thus, the resulting set of values 520 is a set of values that uniquely identify all data items in a tuple including any associated annotations 440. The set of values 520 are stored in the tuple index table 505 and the annotations are stored in an annotation table 510. Alternatively, the set of values 520 and the annotations 440 can be stored together.

As an additional step, each value in the set of values can be hashed using known hashing techniques to provide faster, searching and retrieval of the annotation. Alternatively, one or more of the attributes or values can be hashed to locate a hash bucket and then the correct result obtained by using the identified attributes and values that were not used to generate the hash to search the bucket.

Thus, stored in the annotation data store 305 is a set of values in annotation table 505 that uniquely identify a set of dimension, i.e., points of location references in a view (cell locations), which are associated with an annotation 440. Thus, when a view 335 is refreshed because a) the data from an external data source 225 has been refreshed or b) the query has been re-run, then for each set of dimensions in the view 335, the mapping component 315 queries the tuple index table 505 to identify whether there is a set of dimensions, i.e., tuple references that match the dimensions being displayed in the current view 335. If an identical set of references are located then the associated annotation is queried from the annotation table 510 in the annotation data store 305 and retrieved for displaying with the appropriate data items in the view 335.

A query may be refreshed because the underlying data source has been updated or the query itself has changed. Thus, when the query generator component 340 receives a new query for processing, the query is processed in the manner described above. However, this time, the view generator component 310 needs to determine whether the view that is to be generated comprises any annotations 440 that need to be displayed with an associated data item. This process is handled by the mapping component 315.

When the query generator component 340 returns to the view generator 310 a set of tuples from the query, the mapping component 315 intercepts this communication between the query generator component 340 and the view generator component 310 and begins by analyzing the data items in the tuple.

As before, the first data item in the tuple is identified and a lookup is performed in the index creation table 500 to identify a unique identifier associated with the first data item. The mapping component 315 writes the identified value to memory. Next, the mapping component 315 identifies the second data item in the tuple and performs a lookup in the index creation table 500 and locates a unique identifier associated with the second data item and writes the identified value to memory. This process continues until each data item in the tuple is associated with a unique value located from the index creation table 325.

Thus, the mapping component 315 creates a set of values that uniquely identify the combination of the data items in the tuple, which was the output of the query. However, if the mapping component 315 can not locate a data item in the index table, the process stops and a unique value needs to be created for the data item in the index creator component.

Next, the mapping component 315 takes the created set of values and performs a lookup in the tuple index table 505 to determine whether there is a corresponding unique set of values logged in the tuple index table 505. If the mapping component 315 identifies a corresponding set of values and retrieves the identified set of values along with the associated annotation 440 to the view generator component 310 for generating the view 335 that now includes an annotation 440 associated with a particular tuple.

For example, if the query asks the following:
“How many TV sets were sold in the UK in 2001?”

The query generator component 340 would return the following tuple:
<Product=TV sets, Country=UK, Time=2001, Measure 80,000>

The mapping component 315 takes the above tuple and performs a lookup in the index creation table 500 and creates the following set of values:
<4.5.1.3.10.11.7.8>

At this point it is not known whether there are any annotations already stored for the tuple <Product=TV sets, Country=UK, Time=2001, Measure 80,000>.

Thus the mapping component 315 performs a lookup in the tuple index table 505 for the set of values of <4.5.1.3.10.11.7.8> to identify a corresponding set of values 520. If located, the mapping component 315 writes this value to a mapping table 325. The mapping component 315 continues this process for each item identified in the tuple. For example, if the tuple is:
<product=television sets, country=UK, measure=250000>

The mapping component 315 would derive the following set of values using the information from the index creation table 500.
<4.5.1.3.7.9>

The mapping component 315 performs a lookup in the tuple index table 505 for a corresponding combination of value 520. However, the order of the data values does not matter, just that a set of values 520 comprise the same data values. If a corresponding combination of values is found in one singular value set, then the identified set of values is retrieved. A further lookup is performed to determine if there is a unique generated key 550 associated with the identified set of values and if so then the unique key 550 is used to retrieve an associated annotation.

A reverse lookup is performed to ‘get back’ to the data items from the set of values to enable the view generator component 310 to generate a view 335 that displays the results of a requested query and any associated annotations 440.

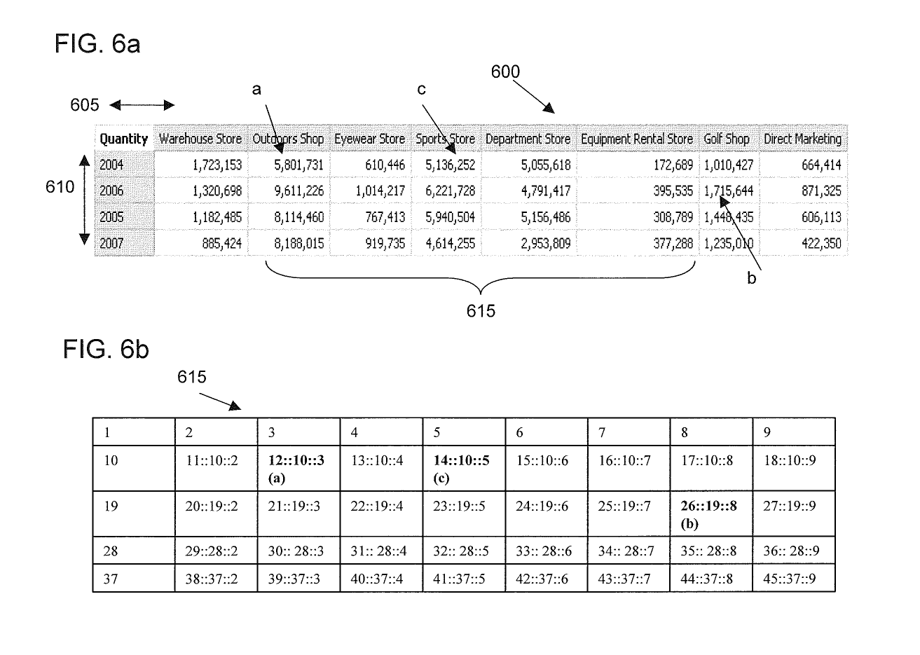

FIG. 6a illustrates an example of a view 335 comprising column headings 605 of a number of different retail outlets. Each of the rows 610 is concerned with a different time period and the data 615 in the cells 615 are the quantities of sales for a particular time period.

Labels a, b and c depict annotations associated with the data values that the arrows are pointing to.

FIG. 6b illustrates the same view as illustrated in FIG. 6a, but illustrates the tuples generated by the index creator component 325 for the data illustrated in FIG. 6a. Thus, for the annotations given in FIG. 6a the following dimensions are given:

a = (2004, Outdoors Shop, Quantity)
b = (2006, Golf Shop, Quantity)
c = (2004, Sports Store, Quantity)

Wherein the tuples generated for annotations a, b and c by the process as described with reference to FIG. 5 are:

a = (12::10::3)
b = (26::19::8)
c = (14::10::5)

and taking the tuple associated with annotation ‘a’, the following code may be generated by the code generator component 330.

```
  <CD useValue=“Outdoors Shop” pun=“8” lun=“7” mun=“12” hun=“9”
    dun=“10” rdi=“11” qry=“4” ctxId=“3”/>
<CD useValue=“2004” pun=“21” lun=“20” mun=“19” hun=“22”
        dun=“23” rdi=“24” qry=“4” ctxId=“10”/>
<CD useValue=“5801731” mun=“1” hun=“2” dun=“3” rdi=“25” qry=“4”
            ctxId=“12”/>
```

It can be seen that the tuple values for annotation ‘a’ is reflected in what is known as the ctxid attribute. The combination of the ctxid attribute is equivalent to the index created in the tuple index table 505 of FIG. 5. The ctxid attribute uniquely identifies an element within a document.

The pun/mun/lun/hun/dun attributes in the above code refers to rows in the data item section of the generated view 335. This is shown in greater detail in the generated code below.

```
  <DA vtype=“2” lun=“[Sales].[Retailer].[Retailer].[Retailer type]”
  uid=“7”/>
  <DA vtype=“1” pun=“[Sales].[Retailer].[Retailer].[Retailer(All)]-
                &gt;[all]” uid=“8”/>
    <DA vtype=“6” hun=“[Sales].[Retailer].[Retailer]” uid=“9”/>
      <DA vtype=“7” dun=“[Sales].[Retailer]” uid=“10”/>
<DA vtype=“3” rdi=“Retailer(All) (visible items with calculations set)”
        dtype=“1” drill=“0” usage=“3” q=“4” h=“9”
        level=“1” uid=“11”/>
  <DA vtype=“0” mun=“[Sales].[Retailer].[Retailer].[Retailer type]-
                &gt;[all].[6]” uid=“12”/>
```

Below is an example code output from the HTML generator component 330 for the tables shown in FIGS. 6a and 6b.

<CONTEXT-METADATA>
<META-DATA>
<DA vtype=“0” mun=“[Sales].[Sales fact].[Quantity]” uid=“1”/>
<DA vtype=“6” hun=“[Sales].[Sales fact]” uid=“2”/>
<DA vtype=“7” dun=“[Sales].[Sales fact]” uid=“3”/>
<DA vtype=“5” qry=“Query1” uid=“4”/>
<DA vtype=“9” uid=“5”/>
<DA vtype=“0” mun=“[Sales].[Retailer].[Retailer].[Retailer type]-&gt;[all].[4]”
uid=“6”/>
<DA vtype=“2” lun=“[Sales].[Retailer].[Retailer].[Retailer type]” uid=“7”/>
<DA vtype=“1” pun=“[Sales].[Retailer].[Retailer].[Retailer(All)]-&gt;[all]”
uid=“8”/>
<DA vtype=“6” hun=“[Sales].[Retailer].[Retailer]” uid=“9”/>
<DA vtype=“7” dun=“[Sales].[Retailer]” uid=“10”/>
<DA vtype=“3” rdi=“Retailer(All) (visible items with calculations set)” dtype=“1”
drill=“0” usage=“3” q=“4” h=“9” level=“1” uid=“11”/>
<DA vtype=“0” mun=“[Sales].[Retailer].[Retailer].[Retailer type]-&gt;[all].[6]”
uid=“12”/>
<DA vtype=“0” mun=“[Sales].[Retailer].[Retailer].[Retailer type]-&gt;[all].[7]”
uid=“13”/>
<DA vtype=“0” mun=“[Sales].[Retailer].[Retailer].[Retailer type]-&gt;[all].[8]”
uid=“14”/>
<DA vtype=“0” mun=“[Sales].[Retailer].[Retailer].[Retailer type]-&gt;[all].[2]”
uid=“15”/>
<DA vtype=“0” mun=“[Sales].[Retailer].[Retailer].[Retailer type]-&gt;[all].[5]”
uid=“16”/>
<DA vtype=“0” mun=“[Sales].[Retailer].[Retailer].[Retailer type]-&gt;[all].[1]”
uid=“17”/>
<DA vtype=“0” mun=“[Sales].[Retailer].[Retailer].[Retailer type]-&gt;[all].[3]”
uid=“18”/>
<DA vtype=“0” mun=“[Sales].[Time dimension].[Time dimension].[Year]-
&gt;[all].[2004]” uid=“19”/>
<DA vtype=“2” lun=“[Sales].[Time dimension].[Time dimension].[Year]”
uid=“20”/>
<DA vtype=“1” pun=“[Sales].[Time dimension].[Time dimension].[Time
dimension(All)]-&gt;[all]” uid=“21”/>
<DA vtype=“6” hun=“[Sales].[Time dimension].[Time dimension]” uid=“22”/>
<DA vtype=“7” dun=“[Sales].[Time dimension]” uid=“23”/>
<DA vtype=“3” rdi=“Time dimension(All) (visible items with calculations set)”
dtype=“1” drill=“0” usage=“3” q=“4” h=“22” level=“1” uid=“24”/>
<DA vtype=“3” rdi=“Default Measure” dtype=“6” drill=“0” usage=“2” q=“4”
h=“2” level=“0” uid=“25”/>
<DA vtype=“0” mun=“[Sales].[Time dimension].[Time dimension].[Year]−
&gt;[all].[2006]” uid=“26”/>
<DA vtype=“0” mun=“[Sales].[Time dimension].[Time dimension].[Year] −
&gt;[all].[2005]” uid=“27”/>
<DA vtype=“0” mun=“[Sales].[Time dimension].[Time dimension].[Year]−
&gt;[all].[2007]” uid=“28”/>
</META-DATA>
<CONTEXT-DATA>
<Block id=“1”>
<CD useValue=“Quantity” mun=“1” hun=“2” dun=“3” rdi=“5” qry=“4”
ctxId=“1”/>
<CD useValue=“Warehouse Store” pun=“8” lun=“7” mun=“6” hun=“9”
dun=“10” rdi=“11” qry=“4” ctxId=“2”/>
<CD useValue=“Outdoors Shop” pun=“8” lun=“7” mun=“12” hun=“9”
dun=“10” rdi=“11” qry=“4” ctxId=“3”/>
<CD useValue=“Eyewear Store” pun=“8” lun=“7” mun=“13” hun=“9”
dun=“10” rdi=“11” qry=“4” ctxId=“4”/>
<CD useValue=“Sports Store” pun=“8” lun=“7” mun=“14” hun=“9” dun=“10”
rdi=“11” qry=“4” ctxId=“5”/>
<CD useValue=“Department Store” pun=“8” lun=“7” mun=“15” hun=“9”
dun=“10” rdi=“11” qry=“4” ctxId=“6”/>
<CD useValue=“Equipment Rental Store” pun=“8” lun=“7” mun=“16” hun=“9”
dun=“10” rdi=“11” qry=“4” ctxId=“7”/>
<CD useValue=“Golf Shop” pun=“8” lun=“7” mun=“17” hun=“9” dun=“10”
rdi=“11” qry=“4” ctxId=“8”/>
<CD useValue=“Direct Marketing” pun=“8” lun=“7” mun=“18” hun=“9”
dun=“10” rdi=“11” qry=“4” ctxId=“9”/>
<CD useValue=“2004” pun=“21” lun=“20” mun=“19” hun=“22” dun=“23”
rdi=“24” qry=“4” ctxId=“10”/>
<CD useValue=“1723153” mun=“1” hun=“2” dun=“3” rdi=“25” qry=“4”
ctxId=“11”/>
<CD useValue=“5801731” mun=“1” hun=“2” dun=“3” rdi=“25” qry=“4”
ctxId=“12”/>
<CD useValue=“610446” mun=“1” hun=“2” dun=“3” rdi=“25” qry=“4”
ctxId=“13”/>
<CD useValue=“5136252” mun=“1” hun=“2” dun=“3” rdi=“25” qry=“4”
ctxId=“14”/>
<CD useValue=“5055618” mun=“1” hun=“2” dun=“3” rdi=“25” qry=“4”
ctxId=“15”/>
<CD useValue=“172689” mun=“1” hun=“2” dun=“3” rdi=“25” qry=“4”
ctxId=“16”/>
<CD useValue=“1010427” mun=“1” hun=“2” dun=“3” rdi=“25” qry=“4”
ctxId=“17”/>
<CD useValue=“664414” mun=“1” hun=“2” dun=“3” rdi=“25” qry=“4”
ctxId=“18”/>
<CD useValue=“2006” pun=“21” lun=“20” mun=“26” hun=“22” dun=“23”
rdi=“24” qry=“4” ctxId=“19”/>
<CD useValue=“1320698” mun=“1” hun=“2” dun=“3” rdi=“25” qry=“4”
ctxId=“20”/>
<CD useValue=“9611226” mun=“1” hun=“2” dun=“3” rdi=“25” qry=“4”
ctxId=“21”/>
<CD useValue=“1014217” mun=“1” hun=“2” dun=“3” rdi=“25” qry=“4”
ctxId=“22”/>
<CD useValue=“6221728” mun=“1” hun=“2” dun=“3” rdi=“25” qry=“4”
ctxId=“23”/>
<CD useValue=“4791417” mun=“1” hun=“2” dun=“3” rdi=“25” qry=“4”
ctxId=“24”/>
<CD useValue=“395535” mun=“1” hun=“2” dun=“3” rdi=“25” qry=“4”
ctxId=“25”/>
<CD useValue=“1715644” mun=“1” hun=“2” dun=“3” rdi=“25” qry=“4”
ctxId=“26”/>
<CD useValue=“871325” mun=“1” hun=“2” dun=“3” rdi=“25” qry=“4”
ctxId=“27”/>
<CD useValue=“2005” pun=“21” lun=“20” mun=“27” hun=“22” dun=“23”
rdi=“24” qry=“4” ctxId=“28”/>
<CD useValue=“1182485” mun=“1” hun=“2” dun=“3” rdi=“25” qry=“4”
ctxId=“29”/>
<CD useValue=“8114460” mun=“1” hun=“2” dun=“3” rdi=“25” qry=“4”
ctxId=“30”/>
<CD useValue=“767413” mun=“1” hun=“2” dun=“3” rdi=“25” qry=“4”
ctxId=“31”/>
<CD useValue=“5940504” mun=“1” hun=“2” dun=“3” rdi=“25” qry=“4”
ctxId=“32”/>
<CD useValue=“5156486” mun=“1” hun=“2” dun=“3” rdi=“25” qry=“4”
ctxId=“33”/>
<CD useValue=“308789” mun=“1” hun=“2” dun=“3” rdi=“25” qry=“4”
ctxId=“34”/>
<CD useValue=“1448435” mun=“1” hun=“2” dun=“3” rdi=“25” qry=“4”
ctxId=“35”/>
<CD useValue=“606113” mun=“1” hun=“2” dun=“3” rdi=“25” qry=“4”
ctxId=“36”/>
<CD useValue=“2007” pun=“21” lun=“20” mun=“28” hun=“22” dun=“23”
rdi=“24” qry=“4” ctxId=“37”/>
<CD useValue=“885424” mun=“1” hun=“2” dun=“3” rdi=“25” qry=“4”
ctxId=“38”/>
<CD useValue=“8188015” mun=“1” hun=“2” dun=“3” rdi=“25” qry=“4”
ctxId=“39”/>
<CD useValue=“919735” mun=“1” hun=“2” dun=“3” rdi=“25” qry=“4”
ctxId=“40”/>
<CD useValue=“4614255” mun=“1” hun=“2” dun=“3” rdi=“25” qry=“4”
ctxId=“41”/>
<CD useValue=“2953809” mun=“1” hun=“2” dun=“3” rdi=“25” qry=“4”
ctxId=“42”/>
<CD useValue=“377288” mun=“1” hun=“2” dun=“3” rdi=“25” qry=“4”
ctxId=“43”/>
<CD useValue=“1235010” mun=“1” hun=“2” dun=“3” rdi=“25” qry=“4”
ctxId=“44”/>
<CD useValue=“422350” mun=“1” hun=“2” dun=“3” rdi=“25” qry=“4”
ctxId=“45”/>
</Block>
</CONTEXT-DATA>
</CONTEXT-METADATA>

The code generator component 330 communicates the output to view generator component 310 for rendering the view 335 output into the table shown in FIG. 6a. Thus, it can be seen that once an annotation is associated with a data item it does not matter if the underlying data source is updated, the query is refreshed and a different set of dimensions are displayed in the view (thus changing the original organizational structure of the view), and the annotation will always be displayed with its associated data item.

Annotations can also be grouped together at the report level and thus annotations that are only related to a particular report may be displayed. This is achieved by introducing a report id and annotations can be linked to the report id as a filter mechanism. Other grouping and filtering mechanisms can be introduced to provide ‘drill down and drill through’ capabilities to different levels and aspects of the views.

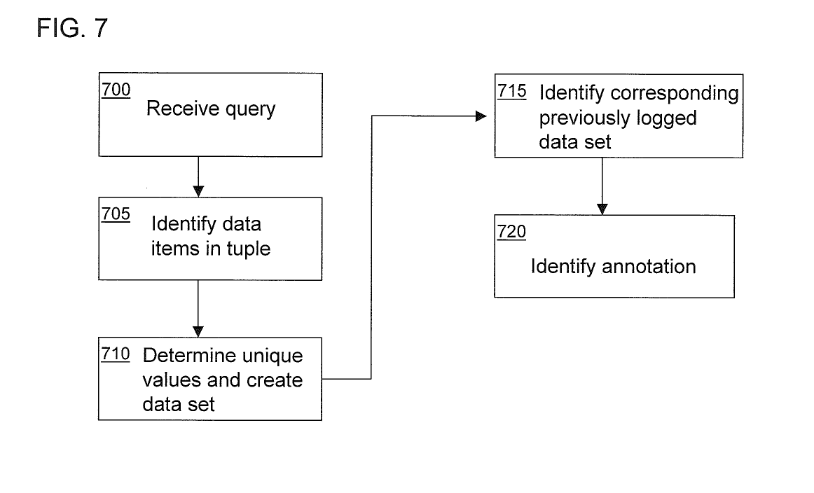

FIG. 7 illustrates the process flows for retrieving an annotation when a query is refreshed and viewed by a user.

At step 700, a query is received by the query generator component 340 and an underlying data source 225 is queried. A set of results is returned. At step 705, the output of the query is analyzed, by the mapping component 315, to identify one or more data items in each dimension of the output to identify a unique value 515 associated with each of the data items. At step 710 each of the identified unique values 515 is logged 505 and wherein each of the identified unique values form a set of unique values representing each of the identified data items in the output of the query. At step 715, the mapping component 315 identifies from a data store 305 a previously logged set of unique values 520 that correspond to the set of unique values 520 currently being analyzed. In response to a positive determination, determining whether the previously logged unique set of values 520 comprise an associated annotation at step 720 and in response to a positive second determination retrieving the annotation from the data store at step 725.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method of retrieving an annotation associated with a data item in a view, wherein the view is generated by an information management system querying a data source, the method comprising:
receiving an output of a query;
analyzing the output of the query to identify one or more data items, wherein a data item comprises a data value and an attribute associated with the data value;
for each identified data value and attribute, identifying a unique value associated with each of the identified data values and attributes;
identifying from a data store if a data entry that corresponds to the identified unique value;
in response to a positive determination, determining whether the identified unique value is associated with an annotation; and
in response to a positive second determination retrieving the annotation from the data store.

2. The method of claim 1, further comprising displaying in a view each of the identified data items and the associated annotation.

3. The method of claim 1, wherein retrieving the annotation from the data store further comprises mapping each of the unique values associated with each of the identified data values and attributes back to their associated data items as identified in the output to the query and displaying the data items with the associated annotation in a view.

4. The method of claim 1, wherein a data item comprises data and the data's associated attribute that have been retrieved by querying a data source.

5. The method of claim 2, wherein a data's attributes comprises one or more of column and row headings as displayed in a view.

6. The method of claim 1, wherein an annotation comprises one or more of a character string, an integer value, a URL, other pointer or link to an information source.

7. The method of claim 1, wherein an annotation is associated with a data item at any location in a view.

8. The method of claim 1, wherein an annotation is associated with a plurality of data items in one or more views.

9. The method of claim 1, wherein the data source is a data source that is external to the information management system.

10. An apparatus for retrieving an annotation associated with a data item in a view, wherein the view is generated by an information management system querying a data source, the apparatus comprising:
a first component that receives an output of a query;
a second component that analyzes the output of the query to identify one or more data items, wherein a data item comprises a data value and an attribute associated with the data value;
a third component that for each identified data value and attribute, identifies a unique value associated with each of the identified data values and attributes;
a fourth component that identifies from a data store if a data entry corresponds to the identified unique value;
a fifth component that in response to a positive determination, determines whether the identified unique value is associated with an annotation; and
a sixth component that in response to a positive second determination retrieves the annotation from the data store.
a third component that identifies a unique value associated with each data value and each of the data values' attribute, wherein an identified unique value associated with each data value and each identified unique value associated with the attribute forms a unique set of values;
a fourth component that identifies from a data store a previously logged set of unique values that correspond to the set of unique values;
a fifth component that determines whether the previously logged unique set of values comprise an associated annotation, in response to a positive determination; and
a sixth component that retrieves the annotation from the data store, in response to a positive second determination.

11. A computer readable storage medium having computer readable program code stored thereon, that when loaded into a computer system and executed by a processor, implement a method of retrieving an annotation associated with a data item in a view, wherein the view is generated by an information management system querying a data source, wherein the storage medium comprises:
program code for receiving an output of a query;
program code for analyzing the output of the query to identify one or more data items, wherein a data item comprises a data value and an attribute associated with the data value;
for each identified data value and attribute, program code for identifying a unique value associated with each of the identified data value and attributes;
program code for identifying from a data store if a data entry corresponds to the identified unique value;
in response to a positive determination, program code for determining whether the identified unique value is associated with an annotation; and
in response to a positive second determination, program code for retrieving the annotation from the data store.

12. The storage medium of claim 11 further comprising program code for displaying in a view each of the identified data items and the associated annotation.

13. The storage medium of claim 11, wherein the program code for retrieving the annotation from the data store further comprises program code for mapping each of the unique values within the set of unique values back to their associated data items as identified in the output to the query and displaying the data items with the associated annotation in a view.

14. The storage medium of claim 11, wherein a data item comprises data and the data's associated attributes that have been retrieved by querying a data source.

15. The storage medium of claim 12, wherein a data's attributes comprises one or more of column and row headings as displayed in a view.

16. The storage medium of claim 11, wherein an annotation comprises one or more of a character string, an integer value, a URL, other pointer or link to an information source.

17. The storage medium of claim 11, wherein an annotation is associated with a data item at any location in a view.

18. The storage medium of claim 11, wherein an annotation is associated with a plurality of data items in one or more views.

19. The storage medium of claim 11, wherein the data source is a data source that is external to the information management system.

20. A method of retrieving an annotation associated with a data item in a view, wherein the view is generated by an information management system querying a data source, the method comprising:
receiving an output of a query;
analyzing the output of the query to identify one or more data items, wherein a data item comprises a data value and an attribute associated with the data value;
generating an index using at least some of the identified attributes and data values;
using the index to determine if the output of the query is associated with an annotation and;
if the output of the query is associated with an annotation, retrieving the annotation from the data store.

21. The method of claim 20 wherein using the index to determine if the output of the query is associated with an annotation further comprises generating a hash function using the at least some of the identified attributes and data values.

22. The method of claim 21 wherein using the index to determine if the output of the query is associated with an annotation further comprises using both the index and any identified attributes and values not used to generate the hash.

23. A computer-readable storage medium containing program code for retrieving an annotation associated with a data item in a view, wherein the view is generated by an information management system querying a data source, the storage medium comprising:
program code for receiving an output of a query;
program code for analyzing the output of the query to identify one or more data items, wherein a data item comprises a data value and an attribute associated with the data value;
program code for generating an index using at least some of the identified attributes and data values;
program code for using the index to determine if the output of the query is associated with an annotation and;
program code for retrieving the annotation from the data store if the output of the query is associated with an annotation,

24. The storage medium of claim 23 wherein the program code for using the index to determine if the output of the query is associated with an annotation further comprises program code for generating a hash function using the at least some of the identified attributes and data values.

25. The storage medium of claim 24 wherein the program code for identifying if the output of the query is associated with an annotation further comprises program code for using both the index and any identified attributes and values not used to generate the hash.
